(19) United States
(12) Patent Application Publication
(10) Pub. No.: US 2019/0344602 A1
(43) Pub. Date: Nov. 14, 2019

(54) BARREL ASSEMBLY, WRITING INSTRUMENT, AND CONTAINER

(71) Applicant: KOTOBUKI & CO., LTD., Kawagoe-shi (JP)

(72) Inventor: Yoshiyuki SAWAYAMA, Kawagoe-shi (JP)

(21) Appl. No.: 16/518,752

(22) Filed: Jul. 22, 2019

Related U.S. Application Data
(63) Continuation of application No. PCT/JP2018/007077, filed on Feb. 27, 2018.

(30) Foreign Application Priority Data
Feb. 27, 2017 (JP) 2017-034263

(51) Int. Cl. B43K 21/00; B43K 7/00; B43K 24/18; B43K 21/02

(52) U.S. Cl. CPC B43K 21/006; B43K 7/005; A45D 40/06; B43K 21/02; B43K 24/186

(57) ABSTRACT

A barrel assembly according to an embodiment includes one barrel having an annular engaging projection; and another barrel having an engaging projection that protrudes toward the annular engaging projection of the one barrel, wherein the engaging projection of the other barrel has an engaging edge that protrudes in a direction of engagement, the engaging edge further has a protruding molded part that further protrudes from the engaging edge in the direction of engagement, and the protruding molded part of the engaging edge of the other barrel engages with the annular engaging projection of the one barrel.

### CROSS-REFERENCE TO RELATED APPLICATION

This application is based upon and claims the benefit of priority under 35 USC 119 of PCT Application No. PCT/JP2018/007077 filed on Feb. 27, 2018 (Earlier Application is Japanese Patent Application No. JP2017-034263.), the entire disclosure of which, including the description, claims, drawings, and abstract, is incorporated herein by reference in its entirety.

### FIELD

This disclosure relates to a barrel assembly, a writing instrument, and a container, each of that includes one barrel and another barrel which are relatively rotated.

### BACKGROUND

Conventionally, a assembling structure for assembling an inner barrel to an outer barrel is known in which the inner barrel is assembled to an inner side of the outer barrel with the help of an auxiliary barrel and a C ring, wherein the inner barrel is assembled to the inner side of the outer barrel by forming an annular recess on an inner circumferential surface of the outer barrel, the C ring is fitted into the annular recess so that the C ring protrudes further in the inner diameter direction than the inner circumferential surface of the outer barrel, an inner screw is formed on either one of the inner barrel and the auxiliary barrel, an outer screw that screws with the inner screw is formed on the other of the inner barrel and the auxiliary barrel, a part of the inner barrel is inserted into the outer barrel, an end part of a portion of the inner barrel not inserted into the outer barrel is abutted with one end part of the outer barrel, the auxiliary barrel is inserted into the outer barrel from another end part of the outer barrel, apart of the auxiliary barrel or a part of the inner barrel penetrates the C ring, the inner barrel and the auxiliary barrel are coupled to each other by causing the inner screw and the outer screw to screw with each other, and the auxiliary barrel is abutted with a portion of the C ring protruding from the inner circumferential surface of the outer barrel from a side of the other end part of the outer barrel (for example, refer to Japanese Patent Application Laid-open No. 2002-349519 (paragraphs 0016 and 0020, FIGS. 10 and 11, and the like)). According to the assembling structure, an inner barrel can be reliably mounted to an outer barrel with the help of an auxiliary barrel and a C ring.

### DISCLOSURE

According to the conventional barrel assembling structure disclosed in Japanese Patent Application Laid-open No. 2002-349519, one barrel can be assembled to another barrel by means of screw fastening. However, conventionally, there existed a need to provide a barrel assembly, a writing instrument and a container, each of that enables one barrel to be assembled to another barrel so as to be relatively rotatable than conventional one.

This disclosure provides a barrel assembly, a writing instrument and a container, each of that enables one barrel to be assembled to another barrel so as to be relatively rotatable than conventional one.

### SUMMARY

In an aspect of the present invention, the barrel assembly includes one barrel having an annular engaging projection, and another barrel having an engaging projection that protrudes toward the annular engaging projection of the one barrel, wherein the engaging projection of the other barrel has an engaging edge that protrudes in a direction of engagement, the engaging edge further has a protruding molded part that further protrudes from the engaging edge in the direction of engagement, and the protruding molded part of the engaging edge of the other barrel engages with the annular engaging projection of the one barrel.

In addition, in another aspect of the present invention, a writing instrument includes the barrel assembly described above.

Furthermore, in another aspect of the present invention, a container includes the barrel assembly described above.

In the aspects of the present invention, a barrel assembly, a writing instrument and a container, each of that enables one barrel to be assembled to another barrel so as to be relatively rotatable than conventional one can be provided.

### BRIEF DESCRIPTION OF DRAWINGS

FIG. 1 is a side view illustrating an external appearance of a multi-writing tipped writing instrument with a cap according to an embodiment;

FIG. 2 is a sectional view taken along II-II in FIG. 1 of the multi-writing tipped writing instrument with a cap according to the embodiment, the sectional view illustrating a section of a clip included in a cap by rotating the cap 90 degrees in a circumferential direction so that the clip faces upward;

FIG. 3 is an enlarged sectional view illustrating an enlargement of part A in FIG. 2 of the multi-writing tipped writing instrument with a cap according to the embodiment;

FIG. 4 is a perspective view illustrating a front rotating coupling tube as the one barrel in the multi-writing tipped writing instrument with a cap according to the embodiment;

FIG. 5 is a perspective view illustrating a rear rotating coupling tube as the other barrel in the multi-writing tipped writing instrument with a cap according to the embodiment; and

FIG. 6 is a cutaway perspective view illustrating an inner circumferential surface of the rear rotating coupling tube in FIG. 5 by cutting the rear rotating coupling tube along a cutting plane having a normal VI illustrated in FIG. 5.

### DESCRIPTION OF EMBODIMENT

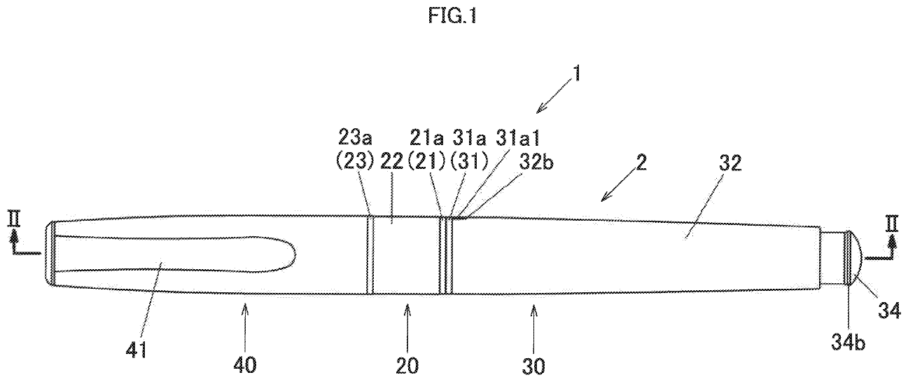

Hereinafter, an embodiment will be described with reference to the drawings. FIG. 1 is a side view illustrating an external appearance of a multi-writing tipped writing instrument with a tip 1 according to an embodiment. The multi-tipped writing instrument with a cap 1 has a barrel 2 including a front barrel 20 and a rear barrel 30, and a cap 40 detachably attached to the front barrel 20 of the barrel 2. In the following description, a side of the front barrel 20 along a longitudinal direction of the multi-writing tipped writing instrument with a cap 1 (hereinafter, referred to as the axial direction) will be referred to be front and a side of the rear barrel 30 that is the opposite side will be referred to be rear.

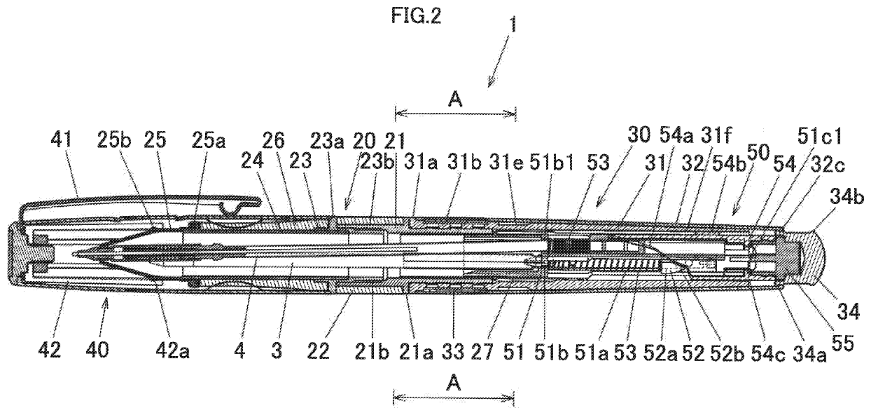

The multi-writing tipped writing instrument with a cap 1 includes a plurality of ball pen refills 3 and a mechanical pencil refill 4 (refer to FIG. 2) and is configured such that, by relatively rotating the front barrel 20 and the rear barrel 30, a writing body of a selected ball pen or mechanical pencil is protruded from a front end opening of a tip fitting 25 to be used. As will be described later, the cap 40 can also be assembled to a click button 34 at a rear end (not illustrated).

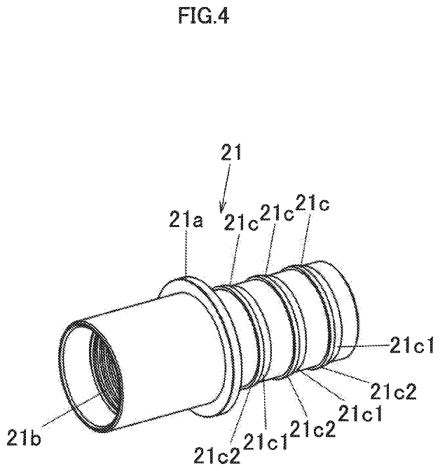

As illustrated in FIG. 2, the front barrel 20 includes a front rotating coupling tube 21 as the one barrel according to the present embodiment. As illustrated in FIGS. 2 and 4, the front rotating coupling tube 21 is formed in an approximately tubular shape and an annular flange 21a is formed approximately at center in the axial direction. A rear surface of the flange 21a abuts with a front surface of a flange 31a formed at a front end of a rear rotating coupling tube 31 (to be described later) and is configured to slide to be rotatable in the circumferential direction. A inner screw part 21b to be fastened to a outer screw part 23b formed on an outer circumferential surface of a rear part of a writing grip fixing tube 23 (to be described later) is formed on an inner circumferential surface of a front part of the front rotating coupling tube 21. Annular engaging projections 21c that engage with an engaging projection 31d of the rear rotating coupling tube 31 (to be described later) are formed on an outer circumferential surface of a rear part of the front rotating coupling tube 21 so as to protrude outward in a radial direction at three locations that are mutually separated by prescribed regular intervals in the axial direction. Each engaging projection 21c includes a front surface that engages with the engaging projection 31d of the rear rotating coupling tube 31 (to be described later), a rear-part inclined part 21c1 having an inclined surface with an outer diameter which is smaller to the rear than to the front, and a flat part 21c2 having an outer circumferential surface which is parallel to the axial direction and which connects the front surface and the inclined part 21c1.

As illustrated in FIG. 2, a rotating operation grip 22 with an approximately tubular shape and formed of a soft elastomer material is assembled on the outer circumferential surface of the front part of the front rotating coupling tube 21 to the front of the flange 21a. In addition, the writing grip fixing tube 23 is assembled to a front end of the front rotating coupling tube 21. The writing grip fixing tube 23 is formed in an approximately tubular shape, and a flange 23a for holding the rotating operation grip 22 and a writing grip 26 (to be described later) is formed toward the front of the writing grip fixing tube 23. The outer screw part 23b is formed on an outer circumferential surface of the writing grip fixing tube 23 to the rear of the flange 23a. The writing grip fixing tube 23 is fixed to the front part of the front rotating coupling tube 21 as the outer screw part 23b and the inner screw part 21b formed on the inner circumferential surface of the front rotating coupling tube 21 described earlier screw with each other. Once the writing grip fixing tube 23 is fixed to the front rotating coupling tube 21, the rotating operation grip 22 is held between a front surface of the flange 21a of the front rotating coupling tube 21 and a rear surface of the flange 23a of the writing grip fixing tube 23. As will be described in detail later, when creating a writing state by rotating the front barrel 20 with respect to the rear barrel 30 and selecting an arbitrary refill, the rotating operation grip 22 formed of a soft material can be gripped and a rotating operation can be performed in a preferable manner.

A grip inner tube 24 is press-fitted and fixed on an inner circumferential surface of a front part of the writing grip fixing tube 23. The tip fitting 25 formed in an approximately conical shape is assembled to a front end of the grip inner tube 24 fixed to the writing grip fixing tube 23. The tip fitting 25 has an opening at a front end thereof and enables tip parts of the ball pen refills 3 and the mechanical pencil refill 4 to be protruded and retracted through the opening of the tip fitting 25. A front end part of the grip inner tube 24 is press-fitted and fixed on an inner circumferential surface of the tip fitting 25. The writing grip 26 with an approximately tubular shape and formed of a soft elastomer material is assembled on an outer circumferential surface of the grip inner tube 24. Once the grip inner tube 24 is fixed to the tip fitting 25, the writing grip 26 is held between a rear surface of a flange 25a formed at a rear end of the tip fitting 25 and a front surface of the flange 23a of the writing grip fixing tube 23 described earlier. When writing with the multi-tipped writing instrument 1 according to the present embodiment, a user can write in a preferable manner by gripping the writing grip 26 formed of a soft material.

A holding tube 27 that holds a guiding member 51 of a cam mechanism 50 (to be described later) is press-fitted and fixed on an inner circumferential surface to the rear of the front rotating coupling tube 21. A front part of the guiding member 51 formed in an approximately tubular shape is press-fitted and fixed on an inner circumferential surface of a rear part of the holding tube 27. A rear part of the guiding member 51 is formed in an approximately cylindrical shape, and a plurality of sliding guides 51a that engage with sliding pieces 52 (to be described later) are formed as a plurality of grooves extending in the axial direction. The sliding guides 51a are formed in a same number as the sliding pieces 52 (to be described later) to which the ball pen refills 3 and the mechanical pencil refill 4 housed in the capped multi-lead writing instrument 1 are respectively attached. A spring supporting part 51b that is a disk wall on which is formed a plurality of through holes 51b1 is formed at a position in the axial direction of the guiding member 51 where a front end of the sliding guide 51a is formed. Each of the plurality of through holes 51b1 of the spring supporting part 51b is formed at a position on the spring supporting part 51b to the front of each of the plurality of sliding guides 51a.

The sliding piece 52 is assembled to the sliding guide 51a so as to be slidable in the axial direction along the sliding guide 51a. A rear end of the ball pen refills 3 or the mechanical pencil refill 4 is press-fitted and assembled to a front part of the sliding piece 52. A cam follower 52a which engages with a cam surface 54a of a cam main body 54 (to be described in detail later) is formed so as to protrude outward in the radial direction on an outer circumferential surface on an outer side in the radial direction of the sliding piece 52 that is assembled to the sliding guide 51a. A pressing spring 53 that is a compression coil spring to be compressed between a front end of the sliding piece 52 and a rear surface of the spring supporting part 51b of the guiding member 51 is arranged on an outer circumference of a rear end part of the refill assembled to the sliding piece 52. The sliding piece 52 is constantly biased rearward by the pressing spring 53 and is pressed onto the cam surface 54a of the cam main body 54 (to be described in detail later). The ball pen refills 3 and the mechanical pencil refill 4 assembled to the sliding piece 52 are guided so as to be movable forward and rearward by the guiding member 51 in a state of being constantly biased rearward by the pressing spring 53 and are selectively moved forward and rearward by the cam mechanism 50 as will be described in detail later.

The front barrel 20 includes the front rotating coupling tube 21, the rotating operation grip 22, the writing grip fixing tube 23, the grip inner tube 24, the tip fitting 25, the writing grip 26, and the holding tube 27 described earlier. The guiding member 51 to which the ball pen refills 3 and the mechanical pencil refill 4 are assembled so as to be movable forward and rearward is integrally fixed to the front barrel 20 by being press-fitted and fixed into the holding tube 27.

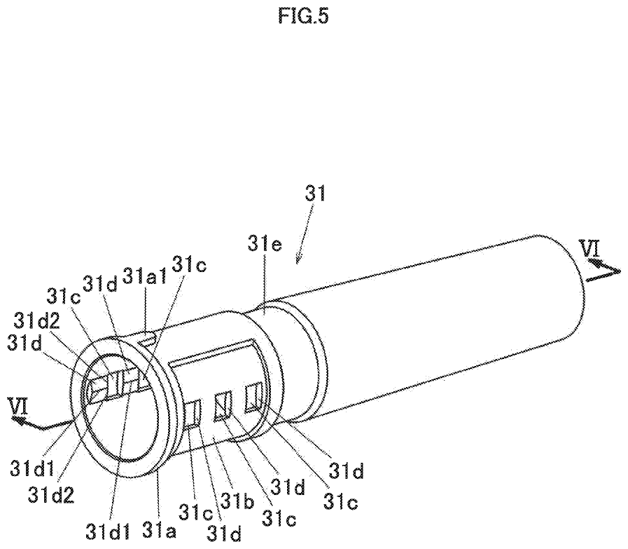

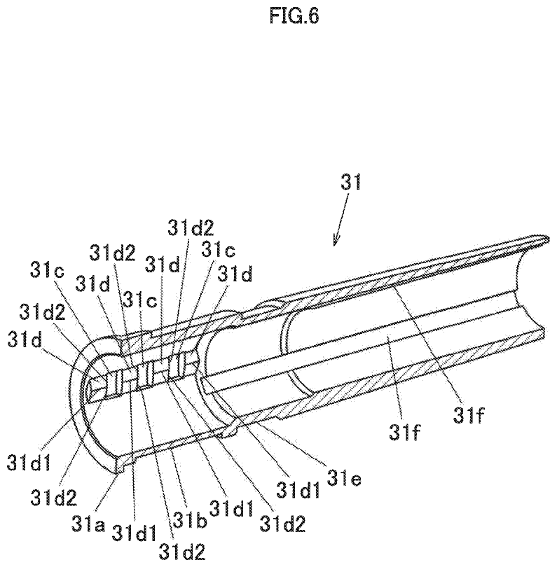

The rear rotating coupling tube 31 as the other barrel according to the present embodiment is assembled so as to be relatively rotatable to the outer circumference of the rear part of the front rotating coupling tube 21 as the one barrel according to the present embodiment. Hereinafter, the rear rotating coupling tube 31 will be described with reference to FIGS. 5 and 6. The flange 31a is formed at the front end of the rear rotating coupling tube 31, and a locking protruding part 31a1 is formed so as to protrude rearward from one location in the circumferential direction of the flange 31a. A front edge of an outer tube 32 assembled to an outer circumference of the rear rotating coupling tube 31 (to be described in detail later) is configured so as to abut with the flange 31a and the locking protruding part 31a1 and, accordingly, the outer tube 32 can be firmly assembled to the rear rotating coupling tube 31 in the axial direction and the circumferential direction. A recess 31b extending in the circumferential direction is formed on an outer circumferential surface of a front part of the rear rotating coupling tube 31 with the exception of an upper part thereof where the locking protruding part 31a1 is formed. An elastic member 33 having a sectional shape formed in an approximately C-shape as viewed from the axial direction (to be described in detail later) is assembled to the recess 31b and is configured so as to capable of even more firmly assembling the outer tube 32 with which the elastic member 33 also engages to the rear rotating coupling tube 31. Three pairs of opposing molded openings 31c which penetrate and open in the radial direction are formed in the recess 31b so as to be separated from each other at regular intervals in the axial direction. As will be described in detail below, forming the molded openings 31c enables an engaging edge 31d2 of the engaging projection 31d that protrudes inward in the radial direction of the rear rotating coupling tube 31 to be sharply formed by resin molding.

On an inner circumferential surface of the rear rotating coupling tube 31 adjacent to each molded opening 31c in the axial direction, the engaging projections 31d are formed so as to respectively protrude in an inner diameter direction from the inner circumferential surface. The engaging projection 31d engages in the axial direction with a front surface of the annular engaging projection 21c of the front rotating coupling tube 21 as described earlier. In the present embodiment, four pairs or a total of eight engaging projections 31d are formed, in which a pair is constituted by two opposing engaging projections 31d. When a large number of engaging projections 31d are formed in this manner, a burden on each engaging projection 31d that engages and slides with the annular engaging projection 21c of the front rotating coupling tube 21 as will be described in detail later can be distributed and reduced. Each of the engaging projections 31d are formed in a shape of which a central part thereof protrudes furthest inward in the radial direction and in which two flat surfaces intersect each other in the central part so as to have a sliding edge 31d1 (to be described in detail later) which extends in the axial direction. The engaging edge 31d2 (to be described in detail below) is formed at rear ends of the two flat surfaces.

The rear rotating coupling tube 31 can be formed by resin molding (for example, injection molding) of a thermoplastic resin material. A resin molding die set (not illustrated) for performing resin molding of the rear rotating coupling tube 31 includes two left and right divided die portions (not illustrated) for molding the outer circumferential surface of the rear rotating coupling tube 31 and the resin molding die is configured so that, when the two divided die portions are closed and aligned from the left and the right, a cavity is formed inside the resin molding die set. An engaging edge molding pin (not illustrated) having wall surfaces for molding the rear end surface and the engaging edge 31d2 of the engaging projection 31d is formed so as to protrude inward in the radial direction from the left and the right on an inner circumferential surface of the cavity. A core pin (not illustrated) of the resin molding die set for molding the inner circumferential surface of the rear rotating coupling tube 31 is inserted along a longitudinal direction (the axial direction) of the rear rotating coupling tube 31 into the cavity formed by closing the two divided die portions of the resin molding die set from the left and right. In the present embodiment, a configuration is adopted in that, at this point, a flat surface formed at a tip of the engaging edge molding pin protruding inward in the radial direction from left and right inner circumferential surfaces of the cavity abuts with left and right side flat surfaces of the core pin. Adopting such a configuration enables a cavity of a resin molding die having minute recesses along an abutting surface between the engaging edge molding pin and the core pin to be formed. A corner part formed on an outer circumference of the tip flat surface of the engaging edge molding pin is normally minutely rounded. Therefore, due to the minute roundness, when the engaging edge molding pin is abutted with a side surface of the core pin that is a flat surface, a minute recess (a parting line) is formed along an outer circumference of the abutting flat surface. A rear end of an inner circumferential surface of the engaging projection 31d of the rear rotating coupling tube 31 molded inside a cavity configured as described above can have a sharp engaging edge 31d2. Specifically, due to resin further flowing from the tip of the engaging edge 31d2 into the minute recess of the resin molding die set, the engaging edge 31d2 can have a protruding molded part that further protrudes in a direction of engagement from the engaging edge 31d2.

The engaging edge 31d2 significantly differs from other edges which have a normal edge radius and which are molded by a processing angle part (not illustrated) having a normal tool processing radius and being formed inside the resin molding die, and is sharp. Forming the engaging edge 31d2 sharp in this manner enables a superior engaging structure to be provided which has less backlash and less sliding resistance (frictional resistance) accompanying rotating operations when the engaging edge 31d2 engages with the engaging projection 21c of the front rotating coupling tube 21 as will be described in detail later. When the molded opening 31c which enables access from an outer side in the radial direction to the engaging edge 31d2 of the engaging projection 31d as in the rear rotating coupling tube 31 according to the present embodiment, the engaging edge molding pin can be inserted inward in the radial direction so as to penetrate the molded opening 31c. Therefore, the engaging edge 31d2 can be formed sharp in a preferable manner.

As in the case of the engaging projection 31d of the rear rotating coupling tube 31, a protruding portion that protrudes in a direction perpendicular to the axial direction is referred to as an undercut shape. Conventionally, there have been cases where, when an undercut shape portion molded as described above is extracted in the axial direction and removed from a resin molding die set or a core pin, an edge of the undercut shape portion abuts with the resin molding die set or the core pin and causes a molded edge to become rounded. In contrast, in molding of the engaging projection 31d of the rear rotating coupling tube 31 according to the present embodiment, a configuration is adopted in which a core pin is extracted in the axial direction after splitting the two, left and right, divided die portions of the resin molding die set to the left and the right to open the molding die set. By adopting such a configuration, the core pin can be extracted in the axial direction after extracting the engaging edge molding pin from the rear rotating coupling tube 31 in the direction perpendicular to the axial direction. Therefore, even when an undercut shape such as the engaging projection 31d of the rear rotating coupling tube 31 is formed, the undercut shape can be removed from the resin molding die set while retaining a sharply molded state of the engaging edge 31d2 of the engaging projection 31d.

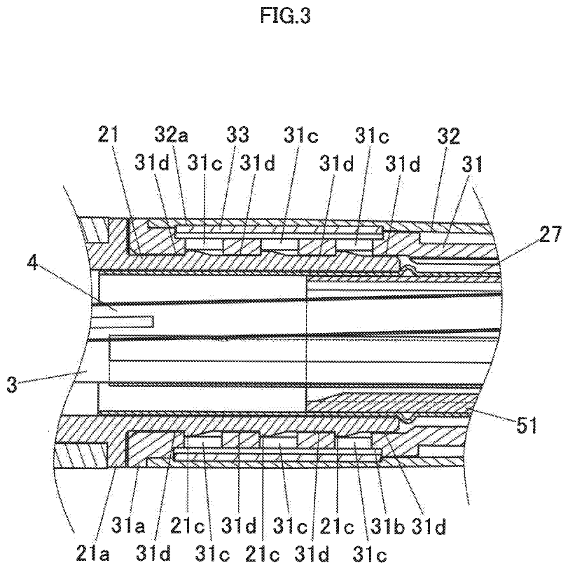

As illustrated in FIG. 3, the front rotating coupling tube 21 and the rear rotating coupling tube 31 are assembled so as to be mutually rotatable and that the plurality of annular engaging projections 21c of the front rotating coupling tube 21 are respectively arranged at positions in the axial direction which correspond to the molded opening 31c of the rear rotating coupling tube 31 (and at the same time, arranged between the engaging projections 31d). The front rotating coupling tube 21 and the rear rotating coupling tube 31 are assembled by inserting the rear end of the front rotating coupling tube 21 into an opening on a forward side of the rear rotating coupling tube 31. When assembling the front rotating coupling tube 21 to the rear rotating coupling tube 31, the engaging projection 31d of the rear rotating coupling tube 31 slides on an outer circumferential surface of the inclined part 21c1 of the engaging projection 21c of the front rotating coupling tube 21 and climbs over the engaging projection 21c. At this point, as described earlier, the sliding edge 31d1 that protrudes most greatly inward in the radial direction is formed in a central part of the engaging projection 31d of the rear rotating coupling tube 31. By adopting such a configuration, only the sliding edge 31d1 comes into line contact with and slides against the inclined part 21c1 of the engaging projection 21c, and the sharply formed engaging edge 31d2 does not slide with the inclined part 21c1 of the engaging projection 21c. Therefore, the sharply formed engaging edge 31d2 can be prevented from becoming rounded due to the assembly of the front rotating coupling tube 21 and the rear rotating coupling tube 31. On the other hand, since the sliding edge 31d1 is molded by a rounded corner part of the resin molding die, the outer circumferential surface of the inclined part 21c1 of the engaging projection 21c is prevented from being scratched.

The sliding edge 31d1 of the engaging projection 31d of the rear rotating coupling tube 31 is configured to, when the front rotating coupling tube 21 is assembled to the rear rotating coupling tube 31, come close to or abut with the outer circumferential surface of the front rotating coupling tube 21 and slide on the outer circumferential surface. By adopting such a configuration, a contact area between the front rotating coupling tube 21 and the rear rotating coupling tube 31 when the front rotating coupling tube 21 and the rear rotating coupling tube 31 are relatively rotationally operated can be decreased and frictional resistance can be reduced. Therefore, the front rotating coupling tube 21 and the rear rotating coupling tube 31 can be readily relatively rotated.

In addition to the description given above, an annular recess 31e is formed to the rear of the recess 31b on the outer circumferential surface of the rear rotating coupling tube 31. The annular recess 31e is formed as a clearance (relief) groove for an adhesive when the outer tube 32 is bonded to the rear rotating coupling tube 31 in order to more firmly assemble an inner circumferential surface of the outer tube 32 (to be described in detail later) to the outer circumferential surface of the rear rotating coupling tube 31. However, the outer tube 32 can be sufficiently firmly assembled to the rear rotating coupling tube 31 simply by fitting the inner circumferential surface of the outer tube 32 onto the outer circumferential surface of the rear rotating coupling tube 31. In addition, three cam locking grooves 31f extending in the axial direction are formed at regular intervals in the circumferential direction on the inner circumferential surface of the rear rotating coupling tube 31 from a position in the axial direction corresponding to a front end of the annular recess 31e to a rear end of the rear rotating coupling tube 31. A locking projection 54b of the cam main body 54 (to be described in detail later) is assembled to the cam locking groove 31f so as to be non-rotatable in the circumferential direction and engages with the cam locking groove 31f, while when a click operation is performed on the mechanical pencil refill 4 using a click button 34 (to be described in detail later), the cam main body 54 is slidable in a front-rear direction.

As illustrated in FIG. 3, the outer tube 32 with an approximately tubular shape is assembled to the outer circumference of the rear rotating coupling tube 31. A pocket 32a that is an annular recess is formed in a portion of an inner circumferential surface of a front part of the outer tube 32 which corresponds in the axial direction to the recess 31b of the rear rotating coupling tube 31. The elastic member 33 having a C-shaped cross section when viewed in the axial direction is assembled between the pocket 32a of the outer tube 32 and the recess 31b of the rear rotating coupling tube 31. An external shape of an inner circumferential surface of the elastic member 33 assembled to the rear rotating coupling tube 31 is formed so as to conform to and fit with an external shape of the recess 31b of the rear rotating coupling tube 31. The elastic member 33 according to the present embodiment is constituted by a curved metal plate and is configured so that a front surface and a rear surface of the elastic member 33 further abut with a front surface and a rear surface of the pocket 32a of the outer tube 32. As described earlier, since a front end of the outer tube 32 abuts with a rear surface of the flange 31a of the rear rotating coupling tube 31, by assembling the elastic member 33, the outer tube 32 is firmly fixed in the axial direction to the rear rotating coupling tube 31. The elastic member 33 is configured so as to have elasticity capable of biasing the rear rotating coupling tube 31 and the outer tube 32 so as to be separated from each other in the radial direction. As described earlier, since a notch 32b is formed at the front end of the outer tube 32 and engages in the circumferential direction with the locking protruding part 31a1 of the rear rotating coupling tube 31, by assembling the elastic member 33, the outer tube 32 is also firmly fixed in the circumferential direction to the rear rotating coupling tube 31.

The cam main body 54 formed in an approximately tubular shape is assembled inside the rear rotating coupling tube 31. The cam surface 54a of which a length of forward protrusion varies in the circumferential direction thereof is formed on a front surface of the cam main body 54. The locking projection 54b that protrudes outward in the radial direction is formed on an outer circumferential surface of the cam main body 54. The locking projection 54b of the cam main body 54 engages so as to be slidable in the axial direction with the cam locking groove 31f which extends in the axial direction and which is formed on the inner circumferential surface of the rear rotating coupling tube 31 described earlier. When a click operation of the click button 34 (to be described later) is performed, the cam main body 54 can slide in the axial direction while being guided by the cam locking groove 31f and actuate a chuck/feed mechanism of a mechanical pencil. On the other hand, since the cam main body 54 is non-rotatably locked with respect to the rear rotating coupling tube 31 in the circumferential direction, the cam main body 54 is configured so as to be capable of relatively rotating in the circumferential direction together with the rear barrel 30 with respect to the front barrel 20 and press an arbitrarily selected refill forward. An annular rib 54c that protrudes inward in the radial direction is formed on an inner circumferential surface of a rear part of the cam main body 54. The annular rib 54c of the cam main body 54 engages with a plurality of engaging hooks 51c of the guiding member 51 which are formed at a rear end of the guiding member 51 and which protrude outward in the radial direction, and rotatably supports the guiding member 51 with respect to the cam main body 54.

A tail plug 55 of which a front part is formed in an approximately tubular shape and a rear part is formed in an approximately cylindrical shape is assembled to rear parts of the cam main body 54 and the guiding member 51. A central projection that protrudes forward is formed on the central axis of the front part of the tail plug 55 and a tubular wall that protrudes forward is formed on an outer circumference of the front part of the tail plug 55. The central projection of the tail plug 55 is inserted into the center of arrangement of the plurality of engaging hooks 51c of the guiding member 51 from the rear and presses each of the plurality of engaging hooks 51c of the guiding member 51 from an inner side in the radial direction toward the annular rib 54c of the cam main body 54 on an outer side in the radial direction. A front end surface of the tubular wall in the front part of the tail plug 55 abuts with a rear surface of the annular rib 54c of the cam main body 54. An outer circumferential surface of the tubular wall in the front part of the tail plug 55 is press-fitted and fixed on an inner circumferential surface of the rear part of the cam main body 54. A flange that protrudes outward in the radial direction is formed on an outer circumferential surface between the front part and a rear part of the tail plug 55, and a front surface of the flange of the tail plug 55 abuts with a rear end surface of the cam main body 54. The click button 34 of which a rear end is formed in a closed approximately tubular shape is assembled so as to be integrally fitted onto an outer circumference of the rear part of the tail plug 55 on an inner side in the radial direction of a rear end of the outer tube 32 which is an outer side in the radial direction of the rear part of the tail plug 55. An annular projection 34a that protrudes outward in the radial direction is formed at a front end of the click button 34, and an annular rib 32c that protrudes inward in the radial direction is formed at the rear end of the outer tube 32. Since the annular projection 34a of the click button 34 engages with the annular rib 32c of the outer tube 32 when the click button 34 recedes, further rearward movement of the click button 34 is restricted. When the click button 34 is clicked forward and a click operation is performed in a state where a tip of the mechanical pencil refill 4 protrudes from a front end opening of the tip fitting 25, the tail plug 55 and the cam main body 54 press the mechanical pencil refill 4 forward against a resilient force of the chuck spring of the mechanical pencil refill 4 and can feed out a writing lead for a mechanical pencil toward the front.

The cam surface 54a of the cam main body 54 comes into sliding contact with a rear end surface of the cam follower 52a of the sliding piece 52. When the cam main body 54 rotates in the circumferential direction, the cam follower 52a and the sliding piece 52 follow the cam surface 54a and move in the axial direction in a state of being guided by the sliding guide 51a of the guiding member 51. When the sliding piece 52 moves forward, the ball pen refill 3 or the mechanical pencil refill 4 assembled to each sliding piece 52 moves forward and a tip of each refill protrudes from the front end opening of the tip fitting 25 and becomes usable.

The rear barrel 30 is configured so as to include the rear rotating coupling tube 31, the outer tube 32, the elastic member 33, and the click button 34 described earlier. The cam mechanism 50 that causes the ball pen refills 3 and the mechanical pencil refill 4 to protrude and recede is configured so as to include the guiding member 51, the sliding piece 52, the pressing spring 53, the cam main body 54, and the tail plug 55 described earlier.

The cap 40 of the multi-tipped writing instrument 1 includes a clip 41. By including an inner tube 42 on which a slit is formed from a rear end thereof, the cap 40 is formed in a double tube shape that further protects refill tips from drying and the like. An annular recess 42a formed in a vicinity of a rear end part of the inner tube 42 detachably fits with an annular fitting projection 25b formed on an outer circumference of the tip fitting 25. On the other hand, when mounting the cap 40 to the rear end of the multi-tipped writing instrument 1, the annular recess 42a of the inner tube 42 detachably fits with a cap engaging projection 34b on an outer circumference of the click button 34. Therefore, even when the cap 40 is mounted to the click button 34, a click operation on the mechanical pencil refill 4 can be performed via the cap 40.

While an embodiment has been described above, it is to be understood that the present invention is not limited to the described embodiment and can be implemented in a wide variety of modes. For example, although the present embodiment describes a case where the present invention is implemented on the multi-tipped writing instrument with a cap 1, the present invention is not limited thereto and can be implemented on any barrel assembly including one barrel and another barrel such as a container for a stick-shaped glue, a container for a rod-shaped plastic eraser, and a container for lipstick and other cosmetic products. In addition, the directions in which the engaging projections on the one and the other barrels protrude are not limited to those described in the protruding part and engaging projections protruding in any arbitrary direction can be provided.

What is claimed is:

1. A barrel assembly, including:
one barrel having an annular engaging projection; and
another barrel having an engaging projection that protrudes toward the annular engaging projection of the one barrel, wherein the engaging projection of the other barrel has an engaging edge that protrudes in a direction of engagement, the engaging edge further has a protruding molded part that further protrudes from the engaging edge in the direction of engagement, and the protruding molded part of the engaging edge of the other barrel engages with the annular engaging projection of the one barrel.

2. The barrel assembly according to claim 1, wherein the other barrel is formed by resin molding, and the other barrel has a molded opening that opens in a radial direction in order to form the engaging edge of the engaging projection of the other barrel.

3. The barrel assembly according to claim 1, wherein the engaging projection of the other barrel further has a sliding edge which extends in an axial direction and which protrudes most greatly in a radial direction.

4. The barrel assembly according to claim 2, wherein the engaging projection of the other barrel further has a sliding edge which extends in an axial direction and which protrudes most greatly in a radial direction.

5. The barrel assembly according to claim 1, further including an outer tube to be assembled to an outer circumference of the other barrel, and a curved, plate-like elastic member extending in a circumferential direction, wherein an annular pocket is formed on an inner circumferential surface of the outer tube, and the elastic member is assembled to the pocket and biases the other barrel and the outer tube so as to separate from each other in the radial direction.

6. The barrel assembly according to claim 2, further including an outer tube to be assembled to an outer circumference of the other barrel, and a curved, plate-like elastic member extending in a circumferential direction, wherein an annular pocket is formed on an inner circumferential surface of the outer tube, and the elastic member is assembled to the pocket and biases the other barrel and the outer tube so as to separate from each other in the radial direction.

7. The barrel assembly according to claim 3, further including an outer tube to be assembled to an outer circumference of the other barrel, and a curved, plate-like elastic member extending in a circumferential direction, wherein an annular pocket is formed on an inner circumferential surface of the outer tube, and the elastic member is assembled to the pocket and biases the other barrel and the outer tube so as to separate from each other in the radial direction.

8. The barrel assembly according to claim 4, further including an outer tube to be assembled to an outer circumference of the other barrel, and a curved, plate-like elastic member extending in a circumferential direction, wherein an annular pocket is formed on an inner circumferential surface of the outer tube, and the elastic member is assembled to the pocket and biases the other barrel and the outer tube so as to separate from each other in the radial direction.

9. A writing instrument including the barrel assembly according to claim 1.

10. A writing instrument including the barrel assembly according to claim 2.

11. A writing instrument including the barrel assembly according to claim 3.

12. A writing instrument including the barrel assembly according to claim 4.

13. A writing instrument including the barrel assembly according to claim 5.

14. A writing instrument including the barrel assembly according to claim 6.

15. A writing instrument including the barrel assembly according to claim 7.

16. A writing instrument including the barrel assembly according to claim 8.

17. A container including the barrel assembly according to claim 1.

18. A container including the barrel assembly according to claim 2.

19. A container including the barrel assembly according to claim 3.

20. A container including the barrel assembly according to claim 5.
